(19) United States
(12) Patent Application Publication
(10) Pub. No.: US 2017/0068924 A1
(43) Pub. Date: Mar. 9, 2017

(54) SPECTACLE-TYPE ELECTRONIC DEVICE, WORK MANAGEMENT SYSTEM, AND INFORMATION MANAGEMENT SERVER

(71) Applicant: KABUSHIKI KAISHA TOSHIBA, Tokyo (JP)

(72) Inventors: Akira Tanaka, Mitaka Tokyo (JP); Yasuhiro Kanishima, Tokyo (JP); Kenichi Doniwa, Asaka Saitama (JP); Hiroaki Komaki, Tachikawa Tokyo (JP); Hiroki Kumagai, Kunitachi Tokyo (JP); Takashi Sudo, Fuchu Tokyo (JP); Nobuhide Okabayashi, Tachikawa Tokyo (JP)

(73) Assignee: KABUSHIKI KAISHA TOSHIBA, Tokyo (JP)

(21) Appl. No.: 14/979,212

(22) Filed: Dec. 22, 2015

(30) Foreign Application Priority Data
Sep. 4, 2015 (JP) 2015-174464

(51) Int. Cl. G06Q 10/06; H04W 4/02; H04B 1/3827

(52) U.S. Cl. CPC G06Q 10/063114; H04B 1/385; H04W 4/02; H04B 2001/3866

(57) ABSTRACT

According to one embodiment, a spectacle-type electronic device of the embodiment is used for a work management system including an information management server which receives items of status information transmitted from targets of work, respectively, and determines an occurrence of abnormality of each of the targets of work based on the items of status information, and a control device which manages workers working on the targets of work. The spectacle-type electronic device is provided for each of the workers who work on the targets of work, transmits worker information indicating a position and a work status of each worker to a communication device, receives information from the communication device, and presents the received information to the workers.

### CROSS-REFERENCE TO RELATED APPLICATIONS

This application is based upon and claims the benefit of priority from Japanese Patent Application No. 2015-174464, filed Sep. 4, 2015, the entire contents of which are incorporated herein by reference.

### FIELD

Embodiments described herein relate generally to a spectacle-type electronic device, a work management system, and an information management server.

### BACKGROUND

Among electronic devices, as a wearable device providing, for example, various kinds of video content or information such as messages in the extension of a line of the wearer's sight, a spectacle-type electronic device (hereinafter referred to as a spectacle-type wearable device or a wearable device) has been put to practical use. This type of wearable device can provide not only information to the wearer, but also report the wearer's positional information or operating statuses, such as the information regarding the wearer's status that the wearer is moving around from a certain point within a predetermined range, staying at a certain position and executing the repetitive operations, or is not moving at all from where he/she is at, without requiring a direct operation by the wearer. Also, information for assisting the wearer's operation can be displayed virtually by video or a message to the wearer. Accordingly, such a technique is useful for work assistance and process management for the wearer in a factory, and the labor management of the wearer, for example.

Meanwhile, in a factory having many manufacturing apparatuses, while the rate of operation of the manufacturing apparatuses affects the production of manufactured goods, the operation is forced to be stopped by a regular maintenance check of the manufacturing apparatuses, sudden trouble or repairs. In this case, when the status that an operation cannot be performed is prolonged, the rate of operation is reduced, thereby reducing the production of goods to be manufactured. Accordingly, it is required to reduce the stop time of the manufacturing apparatuses as much as possible, manage the work statuses so that the workers can efficiently perform the operation, and provide assistance such as instructing the specifics, timing, etc., of the work.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a schematic diagram showing an example of a work management system according to an embodiment.

FIGS. 2A and 2B are schematic diagrams each showing an example of an embodiment of a wearable device of the system according to the embodiment.

FIG. 3 is a schematic diagram showing an example of the embodiment of the wearable device of the system according to the embodiment.

FIG. 4 is a schematic diagram of a system which uses stray light from a light source module of the wearable device of the system according to the embodiment.

FIG. 5 is a schematic diagram for describing a specific application example of a work management system which recognizes the wearable device of the system according to the embodiment.

FIG. 6 is a timing chart showing an example of a communication process of a system which recognizes the wearable device of the system according to the embodiment.

FIG. 7 is a diagram showing a data structure of a communication process of a system which recognizes the wearable device of the system according to the embodiment.

FIG. 8 is a diagram showing a data structure of a communication process of a system which recognizes the wearable device of the system according to the embodiment.

FIG. 9 is a diagram showing a data structure of a communication process of a system which recognizes the wearable device of the system according to the embodiment.

FIG. 10 is a block diagram showing wearable devices of the system according to the embodiment, and the main elements of the system which recognizes the wearable devices.

FIG. 11 is a block diagram showing the main elements of an information management server of the system according to the embodiment.

FIG. 12 is a block diagram showing the main elements of the wearable device of the system according to the embodiment.

FIG. 13 is a block diagram showing the main elements of a system controller of the system according to the embodiment.

FIG. 14 is an illustration showing a display example of a terminal for a manager of the system according to the embodiment.

FIG. 15 is a block diagram showing a structure which collects the positional and status information of the wearable devices of the system according to the embodiment.

FIG. 16 is a flowchart showing a flow of a process of the information management server according to the embodiment.

### DETAILED DESCRIPTION

Various embodiments will be described hereinafter with reference to the accompany drawings.

In general, according to one embodiment, there are provided a spectacle-type electronic device capable of presenting assistance information for work by reporting positional information and operating statuses in the workplace, and a work management system and an information management server capable of presenting adequate assistance information for achieving the efficiency of work to the workers by managing information associated with various work statuses in the workplace, utilizing the features of the spectacle-type electronic device.

According to an embodiment of the present disclosure, the spectacle-type electronic device is used for the work management system, and the work management system includes the information management server configured to receive items of status information transmitted from a plurality of targets of work, respectively, through a network, and to determine an occurrence of abnormality of each of the targets of work based on the items of status information, and a control device for a manager configured to manage workers working on the plurality of targets of work.

The spectacle-type electronic device is provided for each of the workers who work on the plurality of targets of work, and is configured to transmit worker information indicating the position and work status of each worker to a communication device on the network, to receive information from the communication device on the network, and to present the received information to the workers.

An embodiment will further be described with reference to the drawings.

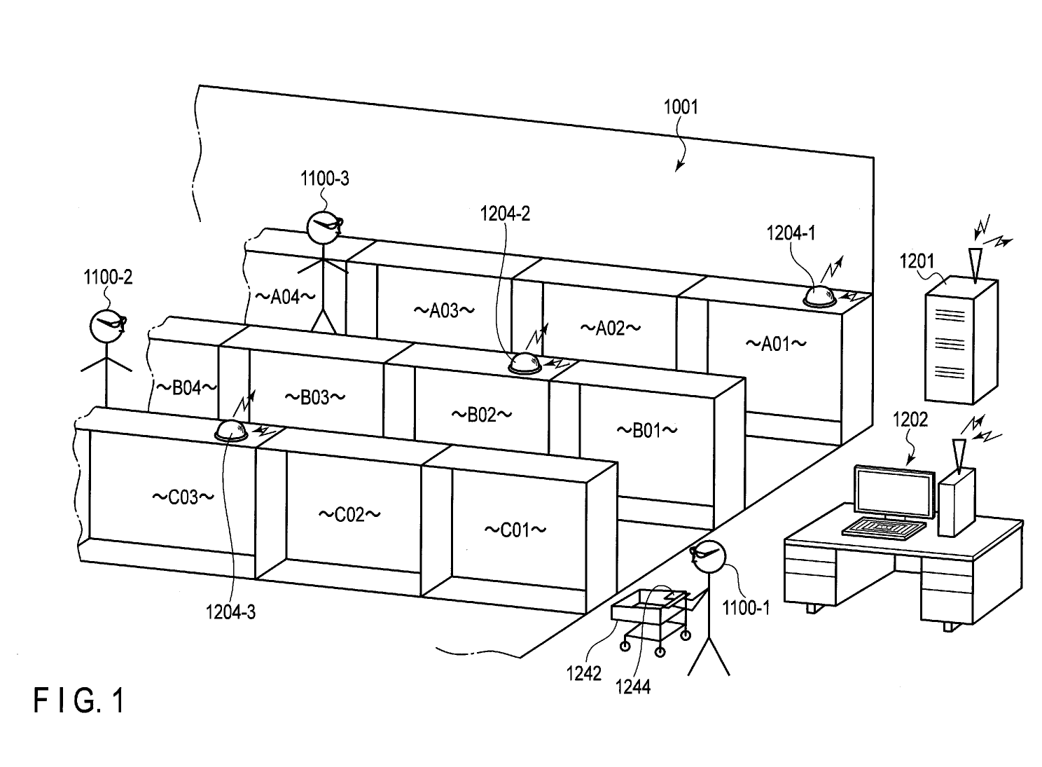

FIG. 1 is a schematic diagram showing an example of a work management system which utilizes a spectacle-type wearable device corresponding to a spectacle-type electronic device according to an embodiment, and communicates with the spectacle-type wearable device which is worn by a worker, thereby managing the work status of each worker with respect to a number of manufacturing apparatuses, and giving instructions to each worker as appropriate. Here, a working environment of a number of manufacturing apparatuses arranged in a production line of a factory is shown as an example. In FIG. 1, in work area 1001, an arbitrary number of manufacturing apparatuses A01 to Axy (where x and y are both positive integers), B01 to Bxy, C01 to Cxy, . . . , and XYxy are arranged, and further, a system controller 1202, which is a terminal for a manager, is arranged at a predetermined position. The system controller 1202 can transfer a signal and data between all of the manufacturing apparatuses A01 to Axy, B01 to Bxy, C01 to Cxy, . . . , and XYxy and an information management server 1201 through a network via wire or wireless communication.

In the work area 1001, at least one sensor wireless chip, i.e., sensor wireless chips 1204-1 to 1204-n (where n is a positive integer), which are positional information transmission portions, capable of communicating with the information management server 1201 and the system controller 1202 through the network are arranged at predetermined positions in a dispersed way.

The above-mentioned sensor wireless chips 1204-1 to 1204-n wirelessly communicate with wearable devices 1100-1 to 1100-m (where m is a positive integer), which are the devices for workers, thereby detecting information indicating the positions or orientations of the respective wearable devices, and recognizing their numbers and a change in the orientation. In this way, by detecting and recognizing the information regarding wearable devices 1100-1 to 1100-m, the positions of the workers holding wearable devices 1100-1 to 1100-m, and the number and status thereof can be ascertained.

Each of the workers can move freely within the work area 1001 while wearing the wearable device. Each of the workers performs a predetermined operation on the scheduled predetermined manufacturing apparatus, and executes a specific operation at a work station 1242 of a movable table or the like, as necessary. A portable management device (input/output device), i.e., a code reader (verifier) or a handy terminal 1244, for example, should preferably be provided removably (integrally) on the work station 1242. Note that the work station 1242 may be a fixed table or the position where the worker sits, etc.

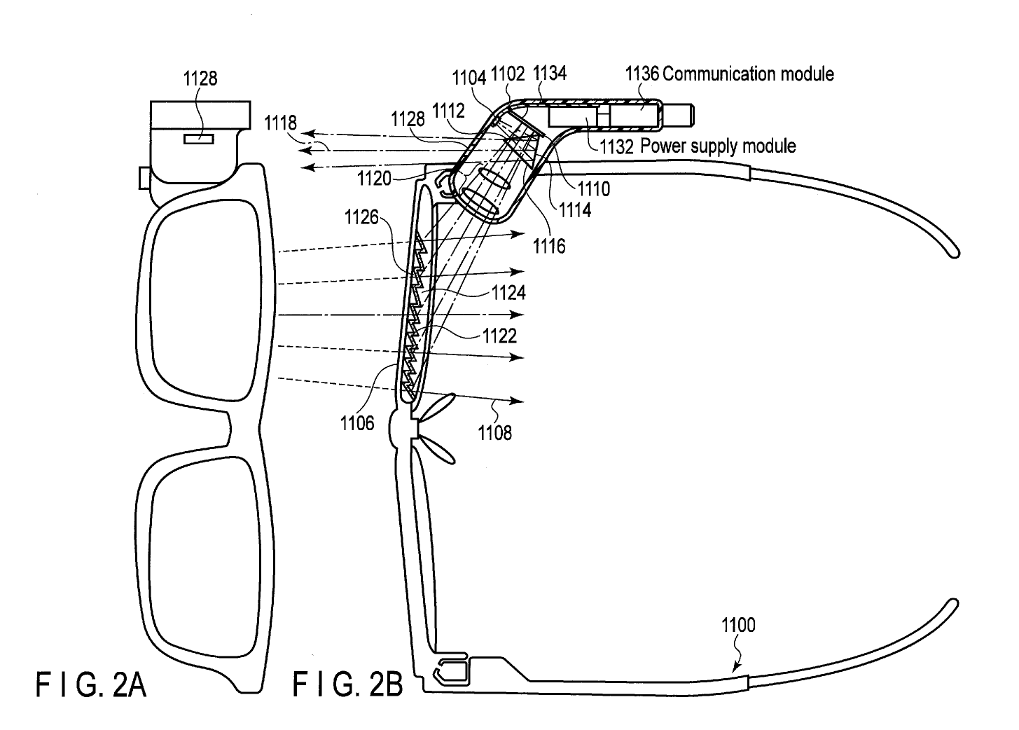

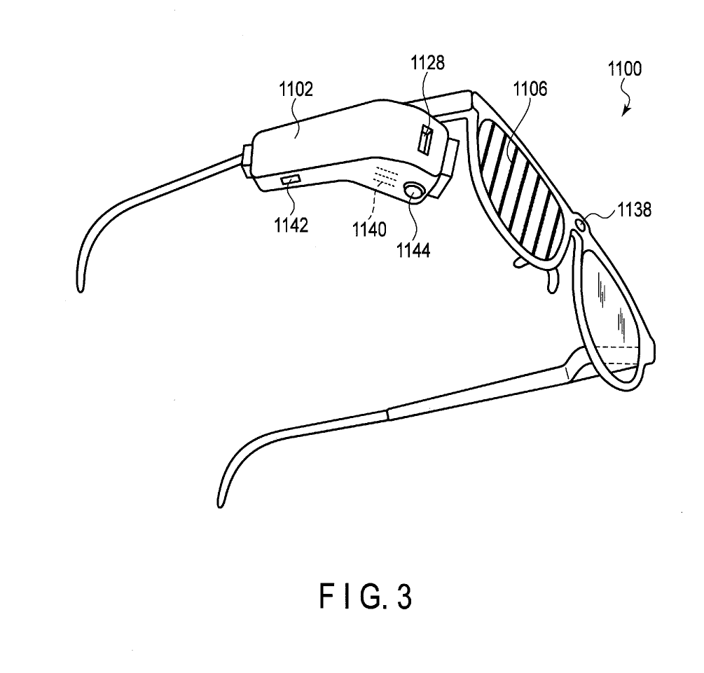

FIGS. 2A, 2B, and 3 are schematic diagrams each showing an example of an embodiment of the wearable device. The wearable device is a spectacle-type electronic device which can perform a communication process as well as information processing. The wearable device may be manufactured as a dedicated device, but a tablet personal computer (PC) or a smartphone, for example, can also be used as an information/communication processing module. In this case, information received by the associated tablet PC or smartphone can be displayed at a predetermined position in the extension of the wearer's line of sight to allow hands-free recognition.

Note that the wearable device can input a predetermined instruction (control information) with respect to a camera function, a sound/speech acquisition function, a vibration detection function, etc., based on the indication of intention by the wearer. As the wearer's indication of intention, the wearer may, for example, block a lens portion of a camera which realizes the camera function with his/her hand, clap his/her hands or utter a sound requesting the next process with respect to the sound/speech acquisition function, give a predetermined vibration with respect to the vibration detection function, etc. The embodiment will hereinafter be described assuming that the wearable device is a spectacle-type device (or may be a head-mounted-display) which can be used by the wearer (worker) with his/her hands free.

In FIGS. 2A, 2B, and 3, a wearable device 1100 comprises a projector (a display information generator) 1102, a screen (an optical path synthesizer) 1106, a driver (often called an image display circuit, a light source driving circuit or a signal processor) 1134, a wireless communication module 1136, etc., and operates with the power supplied from a power supply module 1132 which is, for example, a button battery.

The projector 1102 communicates with the information management server 1201 and the system controller 1202 through the wireless communication module 1136, and these elements mutually transfer information. In addition, the projector 1102 comprises a light source module 1104, an additional image display module 1110, a prism including a half-mirror surface 1112, a total-reflection surface 1114, and an emission surface 1116, a lens group 1120, etc. The projector 1102 illuminates an image or information displayed by the additional image display module 1110 by non-parallel light (diverging light; hereinafter referred to as divergent light) emitted from the light source module 1104, and emits (outputs) the projected image which is the reflected light of the illumination light.

The light source module 1104 should preferably be a dimming-type white LED light source (L-cos) comprising a plurality of (three, for example) light emitting diodes (LEDs) whose luminescent colors are different from each other, and in which an output light quantity of each diode is independently variable. Further, since the dimming-type white LED light source is used for the light source module 1104, if the use environment of the wearable device 1100 is, for example, a clean room in which illumination of mainly orange, for example, is commonly used, the luminescent color can be changed according to the use environment. In addition, by using the dimming-type white LED light source as the light source module 1104, a display color which can easily be seen by the wearer can be output. Consequently, as compared to the case of outputting a display color which is hard to be seen by the wearer, causes of trouble for the wearer, such as eyestrain and a migraine caused by the eyestrain, can be avoided.

The additional image display module 1110 is, for example, a reflection liquid crystal display (LCD) module, and displays a predetermined additional image based on display control of the driver 1134.

Light 1108 output from the light source module 1104 is reflected on the half-mirror surface 1112 to illuminate the additional image displayed by the additional image display module 1110, and is reflected again as additional image light (which may also be referred to as image light) corresponding to the additional image.

The driver 1134 also controls emission of light from the light source module 1104 in association with the additional image (additional image light) displayed by the additional image display module 1110.

The screen 1106 comprises a front-side transparent refractor 1124, a Fresnel-lens-type half-mirror surface 1122, and a rear-side transparent refractor 1126.

The light (image light) 1108 reflected on the additional image display module 1110 to the screen 1106 passes through the half-mirror surface 1112 and the emission surface 1116, is given a predetermined image size by the lens group 1120, and reaches the Fresnel-lens-type half-mirror surface 1122 of the optical path synthesizer 1106.

Part of the additional image light 1108 which has passed through the lens group 1120 and reached the Fresnel-lens-type half-mirror surface 1122 of the screen 1106 is reflected on the Fresnel-lens-type half-mirror surface 1122 and forms a virtual image corresponding to the additional image (image light) displayed on the additional image display module 1110.

The screen 1106 displays an image in such a way that the wearer can visually recognize the image which which has transmitted through a part of image seen in the extension of a line of sight of the wearer (wearing the wearable device 1100), i.e., a background image, together with the image light corresponding to the additional image.

Part of the image light (divergent light) 1108 emitted from the light source module 1104 and passed through the half-mirror surface 1112 makes total reflection on the total-reflection surface 1114, refracted on the emission surface 1116, and becomes stray light 1118 (i.e., divergent light) from the light source module 1104. The stray light 1118 is released to the outside through an opening or a gap (a guide portion) 1128.

As shown in FIG. 3, the wearable device 1100 comprises a speaker 1140, a (slide) switch 1142, a (rotary) knob 1144, etc., at a predetermined position of the projector 1102, for example, on a bottom surface portion of the projector 1102. The switch 1142 can adjust luminance of the additional image light 1108 emitted from the projector 1102, for example. The knob 1144 can adjust an angle of projection of the additional image light 1108 emitted from the projector 1102, for example. As the switch 1142 and the knob 1144 can be set so that an amount of adjustment can be determined by different operations, the wearer (the user) can adjust the luminance and the angle of projection while observing the additional image projected onto the screen 1106, i.e., without looking at the switch 1142 and the knob 1144. In other words, the display luminance or color tone of the additional image which suits the preference of the user (the wearer) can be provided by operating the switch 1142. In addition, the angle of projection can be adjusted by the knob 1144 such that the additional image can be displayed at the most suitable position in accordance with the shape and size of the head of the user (the wearer). Further, needless to say, the features to be adjusted by the switch 1142 and the knob 1144 may be reversed, and the positions of the switch 1142 and the knob 1144 may also be reversed.

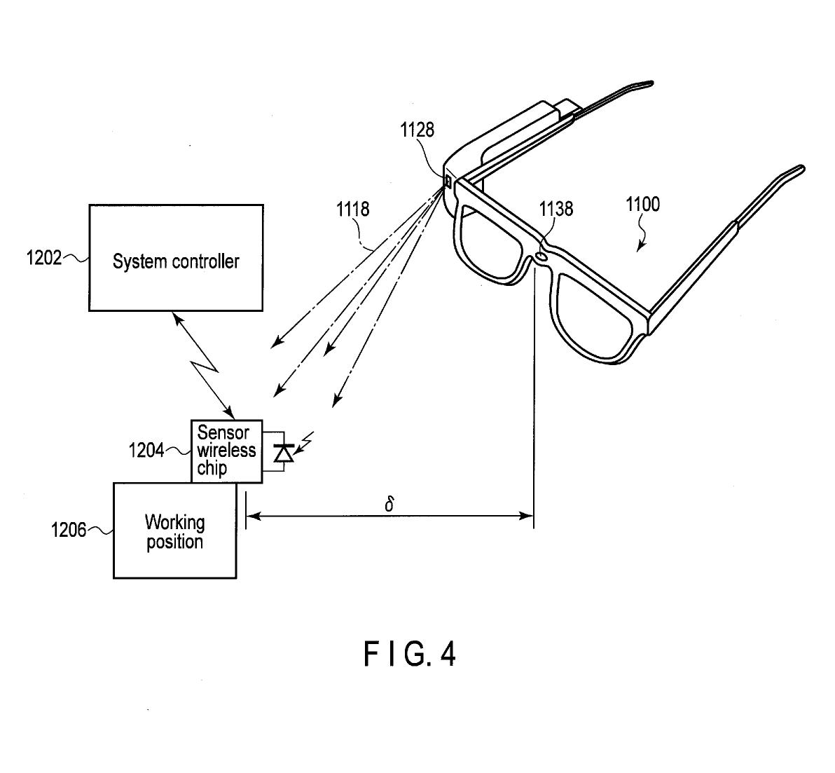

By using the stray light from the wearable device shown in FIGS. 2A, 2B and 3, the position of the wearable device (the wearer) and the wearer's status can be detected. By referring to FIG. 4, a detection principle of the position of the wearable device (the wearer) and the status of the wearer will be described.

FIG. 4 is a schematic diagram showing a basic concept of a system of the embodiment which uses the stray light 1118 from the light source module 1104 of the wearable device 1100.

The work management system of the embodiment includes at least one wearable device 1100 (-1 to -m), at least one sensor wireless chip 1204 (-1 to -n), and one system controller 1200. They can receive and deliver information by mutual communications. The mutual communications may be wired or wireless communications, but should preferably be, for example, near field communication by means of Bluetooth, in particular. More preferably, as they cooperate with each other via the near field communication, cooperative operations and cooperative processes can be executed without being affected by the free movement (or change in the arrangement location) of the wearable device (1100) (or the sensor wireless chip 1204).

In the work management system of the embodiment, the light 1108 output from the light source module 1104 of the wearable device 1100 is intermittently modulated by using information including identification information of the wearable device (identification; may hereinafter be referred to as a device ID) such that individual identification information, i.e., an arbitrary number of wearable devices 1100, can be identified. (The light 1108 emitted from the light source module 1104 is modulated by an information signal including the device ID.) That is, in the work management system of the embodiment, the wearable device 1100 is used as an “information transmission source” by using the stray light 1118. As described above, the wearable device 1100 can be made multifunctional by providing an information transmission function besides the display function which is widely known for the wearable device 1100. In this way, versatility of the system including the wearable device 1100 can be achieved.

Also, in the work management system of the embodiment, the stray light 1118 which is the divergent light from the light source module 1104 is used. In this way, the amount of light detected by the sensor wireless chip 1204 is varied in accordance with distance δ between the wearable device 1100 and the sensor wireless chip 1204. By using this phenomenon, a distance between the wearable device 1100 and the sensor wireless chip 1204 (or the orientation of the wearable device 1100 to the sensor wireless chip 1204) can be predicted.

By using the divergent light as the stray light 1118 from the light source module 1104, the light can be detected within a comparatively wide range. As a result, detection of the position of the wearable device 1100 (i.e., a distance between the wearable device 1100 and the sensor wireless chip 1204) or detection of the orientation of the wearable device 1100 (the orientation of the wearable device 1100 to the sensor wireless chip 1204) can be carried out by merely installing a comparatively small number of sensor wireless chips 1204 (-1 to -n). An expense of installing the detection system can thereby be reduced.

The light amount information of the stray light 1118 from the light source module 1104, which is detected by the sensor wireless chip 1204, is transmitted from the sensor wireless chip 1204 to the system controller 1202 (or the information management server 1201) at a predetermined timing. The system controller 1202 analyzes the information from the sensor wireless chip 1204 which is collected by the system controller 1202 (or compiled in the information management server 1201). In this way, the position of an arbitrary wearable device 1100 (-1 to -m), i.e., the wearer, and the wearer's status can be estimated.

In the embodiment shown in FIG. 4, the sensor wireless chip 1204 is fixed to a workbench 1206 (the place near manufacturing apparatuses A01 to XYxy in FIG. 1), and the wearable device 1100 is movable. Alternatively, the sensor wireless chip 1204 (and the workbench 1206) can be made movable. In that case, the movement of the sensor wireless chip 1204 (and the workbench 1206) may be read by the wearable device 1100 arranged at a fixed position.

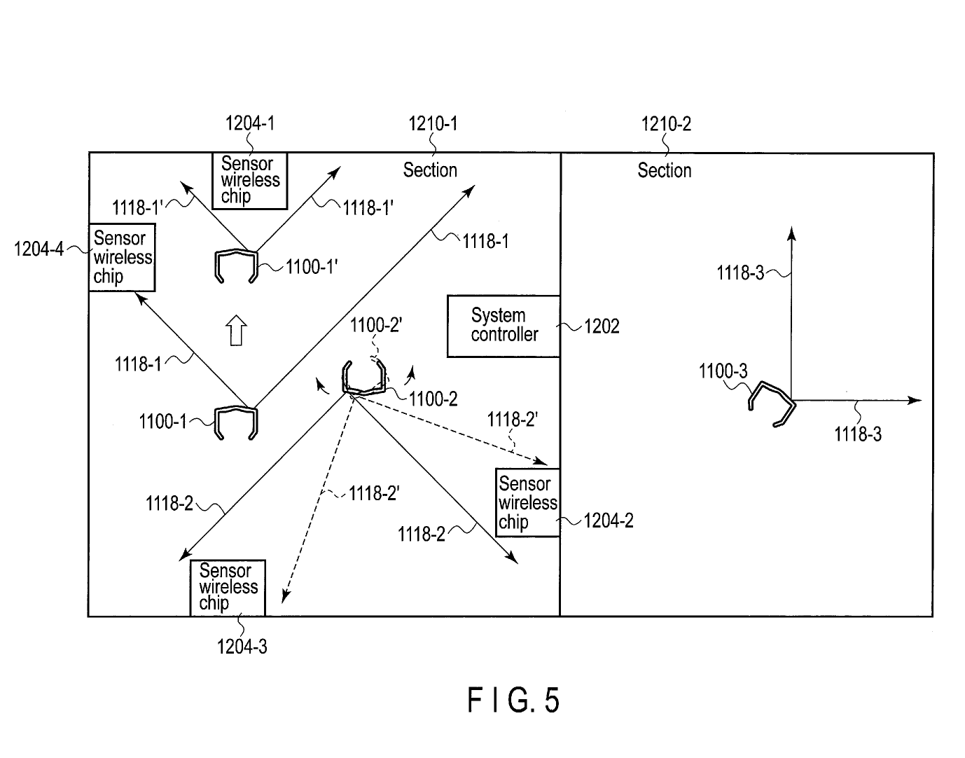

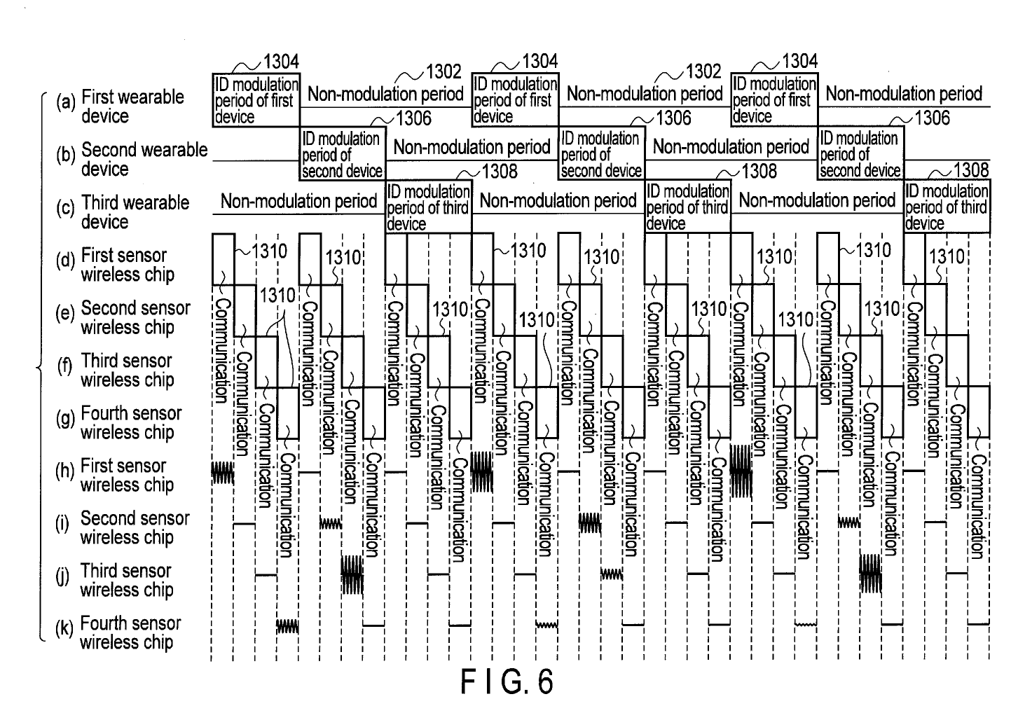

FIG. 5 is a schematic diagram for describing a specific application example of the work management system which recognizes the spectacle-type electronic device according to the embodiment.

Referring to FIG. 5, an example of the case where a system (the work area 1001 in FIG. 1) managed by the system controller 1202 is divided into two sections, i.e., section 1210-1 and 1210-2, will be described. Sections 1210-1 and 1210-2 may be sections divided by a partition, for example.

In FIG. 5, a case where wearable device 1100-1 (a first wearer) and wearable device 1100-2 (a second wearer) move in section 1210-1, and wearable device 1100-3 (a third wearer) is positioned at a predetermined place (i.e., stays at substantially a constant position) in section 1210-2 is assumed. It is assumed that four sensor wireless chips (positional information transmission portions) 1204-1 to 1204-4 are arranged in section 1210-1. The amount of light (the stray light 1118) from arbitrary wearable devices 1100 (-1 to -3) in section 1210-1 is detected by respective sensor wireless chips 1204-1 to 1204-4. Sensor wireless chips 1204-1 to 1204-4 perform analog-to-digital (AD) conversion of the amounts of light (the stray light 1118) which have been detected by sensor wireless chips 1204-1 to 1204-4, respectively, which is transmitted to the system controller 1202 by near field communication as the light amount information corresponding to the amount of light at a predetermined timing.

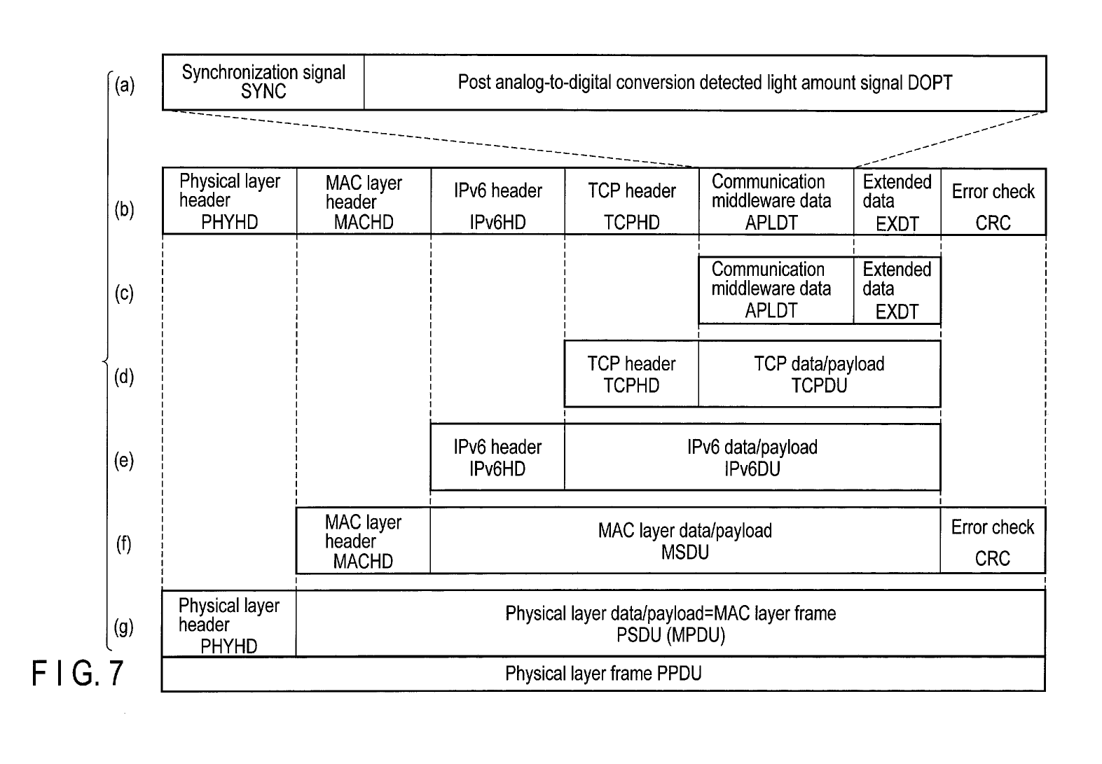

Referring to FIG. 5, the case where wearable device 1100-1 has moved to the direction of sensor wireless chip 1204-1 in accordance with the movement of the wearer, and the orientation of wearable device 1100-2 has temporarily changed in accordance with the wearer's arbitrary movement, for example, turning of the face to right or left (moving the head around), is assumed. FIGS. 6 and 7 show a change in the chronological detection information in the system controller 1202 at this time.

Illustrations of (a) to (c) of FIG. 6 show an example in which an intermittent time-varying method is used as the modulation method of the stray light 1118 from the light source module 1104 of each of wearable devices 1100-1 to 1100-3. That is, in each of wearable devices 1100-1 to 1100-3, the timing at which the light is modulated is shifted (i.e., modulation periods of the respective wearable devices are shifted).

As shown in (a) to (c) of FIG. 6, wearable device ID modulation periods 1304 are set intermittently for the first wearable device 1100-1, and the other periods are set as non-modulation periods 1302. In ID modulation period 1304 of the first wearable device 1100-1, synchronization signal SYNC ((a) of FIG. 7) and the identification information of the wearable device (identification; hereinafter referred to as a device ID) form a pair (that is, correspond with a one-to-one relationship). Such pairing is repeated several times (multiples of four which corresponds to the number (n) of sensor wireless chips 1204 (-1 to -n) in the example shown in FIG. 6).

Simultaneously with the first wearable device 1100-1 entering non-modulation period 1302, ID modulation period 1306 of the second wearable device 1100-2 starts. Similarly, simultaneously with the second wearable device 1100-2 entering non-modulation period 1302, ID modulation period 1308 of the third wearable device 1100-3 starts.

In ID modulation period 1306 of the second wearable device 1100-2 and ID modulation period 1308 of the third wearable device 1100-3, synchronization signal SYNC ((a) of FIG. 7) and the identification information of the corresponding wearable device 1100 (device ID) are repeatedly modulated. As described above, by incorporating identification information (device ID) of the corresponding wearable device 1100 into the modulating signal, the identification information (device ID) can be detected in the system controller 1202. Consequently, since the system controller 1202 can confirm the identification information (device ID) of the wearable device in parallel with the detection timing, the identification accuracy of the wearable device is improved.

In the above example, the modulation timings of respective wearable devices 1100-1 to 1100-3 are time-shared (i.e., set intermittently). However, the modulation in the work management system of the embodiment is not limited to the above, and alternatively, the work management system may be structured such that all of wearable devices 1100-1 to 1100-3 may be modulated continuously, for example, and the modulation reference frequency of each of wearable devices 1100-1 to 1100-3 may be varied. Also, the frequency spectral characteristics at the time of spectral diffusion may be varied.

As shown in (d) to (g) of FIG. 6, periods 1310, which are the periods of information communication from the corresponding sensor wireless chips, are time-divided precisely. Further, in each of sensor wireless chips 1204-1 to 1204-4, communication timings with the system controller 1202 are mutually shifted. The communication timings are managed by the system controller 1202.

In FIG. 5, at an early stage, part of stray light 1118-1 from the light source module 1104 of wearable device 1100-1 reaches sensor wireless chip 1204-4. Accordingly, at the early stage, as shown in (h) and (k) of FIG. 6, each of sensor wireless chips 1204-1 and 1204-4 detects the modulated stray light 1118-1 from the light source module 1104 of wearable device 1100-1. As wearable device 1100-1 moves toward sensor wireless chip 1204-1 from this state, a modulating signal amplitude of stray light 1118-1 from the light source module 1104 of wearable device 1100-1 which is detected by sensor wireless chip 1204-4 is decreased ((k) of FIG. 6). In contrast, a modulating signal amplitude of stray light 1118-1 from the light source module 1104 of wearable device 1100-1 which is detected by sensor wireless chip 1204-1 is increased as time passes ((h) of FIG. 6). In this way, by comparing a temporal change in the modulating signal amplitudes detected by the individual sensor wireless chips 1204 (-1 to -n) in the system controller 1202, a temporal change in the position of the (detection target) wearable device 1100 (-1 to -m) (i.e., the movement) can be estimated.

Meanwhile, at the early stage, when wearable device 1100-2 is directed toward sensor wireless chip 1204-3, an amount of detection of the modulating signal amplitude which can be obtained from stray light 1118-2 from the light source is greater in sensor wireless chip 1204-3 ((j) in FIG. 6) than in sensor wireless chip 1204-2 ((i) in FIG. 6). At this time, a case where the wearer moves his/her head, for example, and temporarily faces the side of sensor wireless chip 1204-2 is assumed. In this case, as shown in (i) of FIG. 6, a detection output (of wearable device 1100-2) output from sensor wireless chip 1204-2 is temporarily increased (which is thereafter decreased) in accordance with stray light 1118-2′ from the light source module 1104. Meanwhile, as shown in (j) of FIG. 6, a detection output (of wearable device 1100-2) output from sensor wireless chip 1204-3 is temporarily decreased in accordance with stray light 1118-2′ from the light source module 1104, and increased again.

In this way, by comparing a temporal change in the modulating signal amplitudes detected by the individual sensor wireless chips 1204 in the system controller 1202, a temporal change in the orientation of the (detection target) wearable device 1100 (-1 to -m) can be estimated.

The above examples of detection illustrate moving of the wearer or turning of the wearer's face as examples of action of the wearer. However, various other behaviors of the wearer may be utilized apart from the above. For example, by the movement of the wearer's hand or (the wearer's) intentional twisting of the upper body, the stray light 1118 from the light source module 1104 may be temporarily shielded. In this case, in all of sensor wireless chips 1204-1 to 1204-4, a modulating signal amplitude is temporarily decreased in common (at the same time frame). As described above, by comparing the relevance of a change in the modulating signal amplitudes of all of the sensor wireless chips 1204-1 to 1204-4, it becomes possible to identify a different behavior pattern of the user.

By utilizing the above method, not only the user's behavior can be merely ascertained, but the user's intention can be conveyed to the system controller 1202. As a result, not only the information is received from the system controller 1202 in one way, but two-way information communication is enabled between the user and the system controller 1202.

FIG. 7 is a schematic diagram showing a data structure example of information provided to the system controller 1202 by the sensor wireless chip (positional information transmission portion).

As shown in FIG. 7, the data structure of information (which is to be transmitted to the system controller) output by the sensor wireless chips (positional information transmission portions) 1204-1 to 1204-4 includes, for example, physical layer header PHYHD, MAC layer header MACHD, IPv6 header IPv6HD, TCP header TCPHD, communication middleware data APLDT, extended data EXDT, and error check CRC. Individual items of information should preferably be transmitted (output) sequentially in the above-mentioned order, for example.

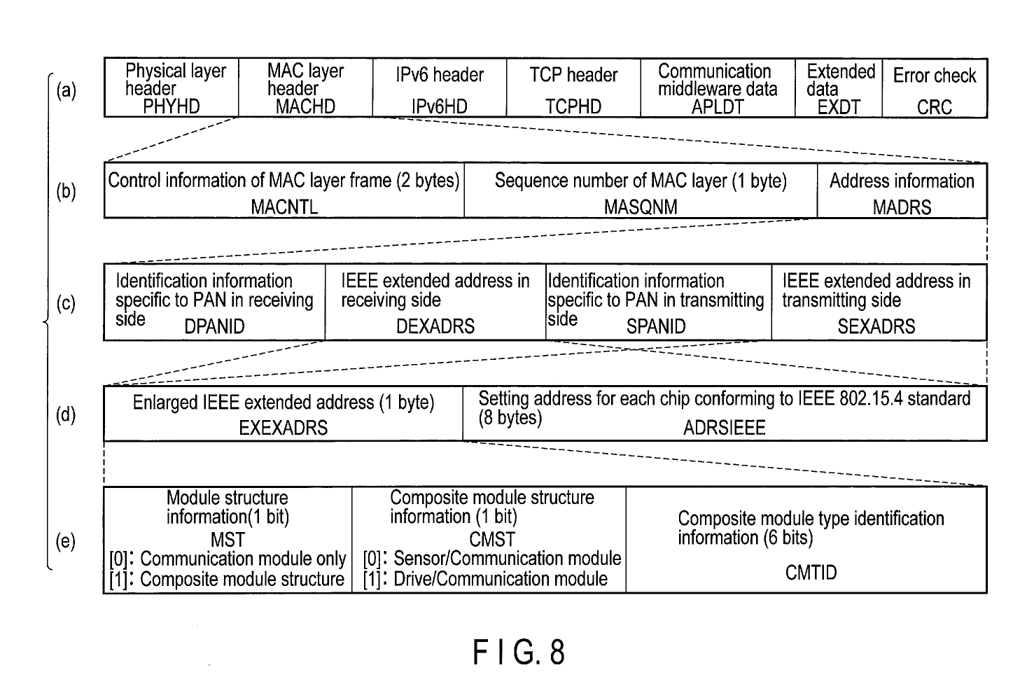

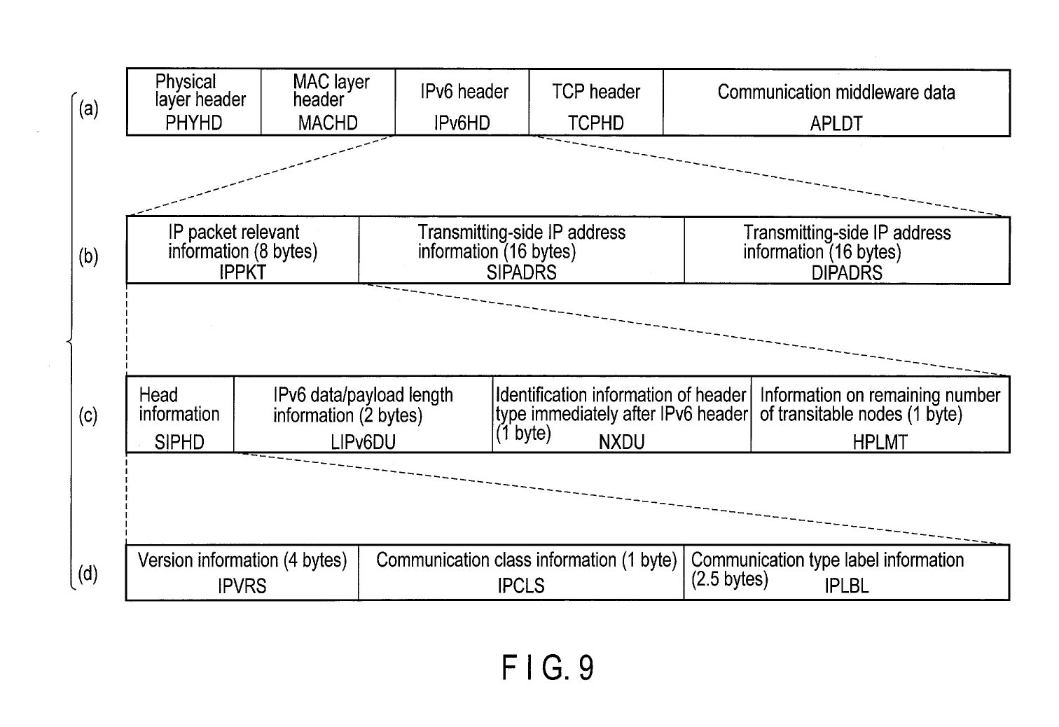

FIG. 8 is a schematic diagram showing a data structure of MAC layer header MACHD of the information shown in FIG. 7, and FIG. 9 is a schematic diagram showing a detailed data structure within IPv6 header IPv6HD.

Items of identification information (hereinafter referred to as a sensor ID) of the respective sensor wireless chips 1204-1 to 1204-4 are recorded in IEEE extended address SEXADRS on the transmission side in (c) of FIG. 8 and/or transmission side IP address SIPADRS in (b) of FIG. 9.

Meanwhile, the identification information of wearable devices 1100-1 to 1100-3 is subjected to analog-to-digital (AD) conversion and stored in post-AD-conversion detected light amount signal DOPT within communication middleware data APLDT as time-varying information, as shown in (a) of FIG. 7. Here, within one transmission of wireless information from the sensor wireless chips 1204 to the system controller 1202, both of the identification information (sensor ID) of sensor wireless chips 1204-1 to 1204-4 and the identification information (device ID) of wearable devices 1100-1 to 1100-3 are transmitted simultaneously. Thus, the system controller 1202 can interpret the behavioral state or transmitted information of each worker accurately with high reliability.

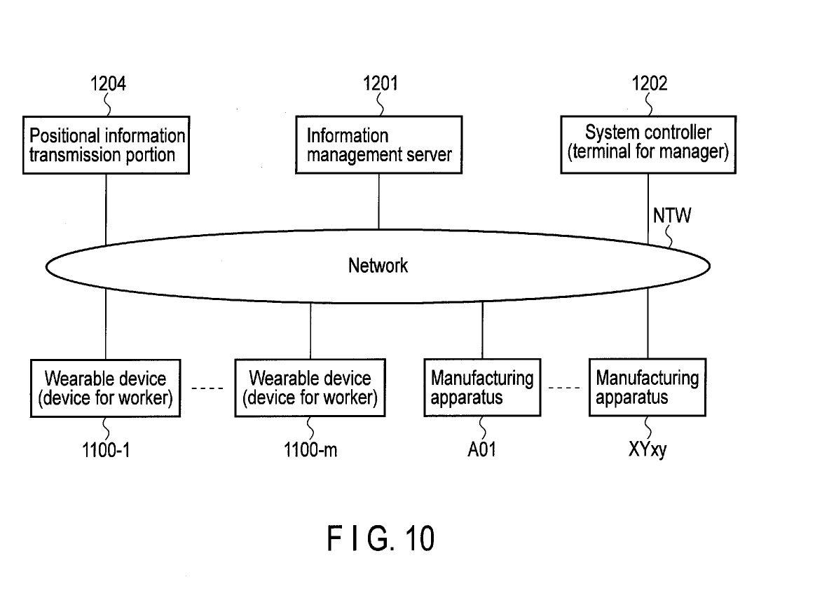

FIG. 10 shows the wearable device (the spectacle-type electronic device), and the main elements of the work management system which recognizes the wearable device as blocks, and is a schematic diagram showing an example of mutual communication (transfer of information and/or data) between the system controller 1202 and the wearable devices shown in FIG. 1.

The system controller (terminal for a manager) 1202, manufacturing apparatuses A01 to XYxy, sensor wireless chips (positional information transmission portions) 1204-1 to 1204-n, and each of wearable devices (devices for workers) 1100-1 to 1100-m can mutually transfer signals through network NTW. The information management server 1201 is connected to network NTW. Also, wearable devices 1100-1 to 1100-m detect (specify) their own positions by receiving position reference signals output from the positional information transmission portions 1204-1 to 1204-n. Together with the worker ID (information specifying the wearer) and the device ID (information specifying the actual device), the position of wearable devices 1100-1 to 1100-m specified by each of wearable devices 1100-1 to 1100-m is reported to the information management server 1201 or the system controller 1202 through network NTW at regular time intervals as the information on the position of the wearer, that is, the worker. Transmission of information on wearable devices 1100-1 to 1100-m by each of wearable devices 1100-1 to 1100-m may be, for example, performed at a predetermined timing in accordance with the timing at which the position reference signals are output by the positional information transmission portions 1204.

Communication between the system controller 1202 (or the information management server 1201) and each of the wearable devices 1100-1 to 1100-m may be wired or wireless. Communication between the system controller 1202 (the information management server 1201) and each of the wearable devices 1100-1 to 1100-m may be, for example, near field communication, and Bluetooth (registered trademark) conforming to the IEEE 802.11 (b/g) standard, for example, should preferably be employed.

Wearable devices 1100-1 to 1100-m also transmit the statuses of the workers to the information management server 1201 when transmitting items of the positional information on wearable devices 1100-1 to 1100-m, respectively.

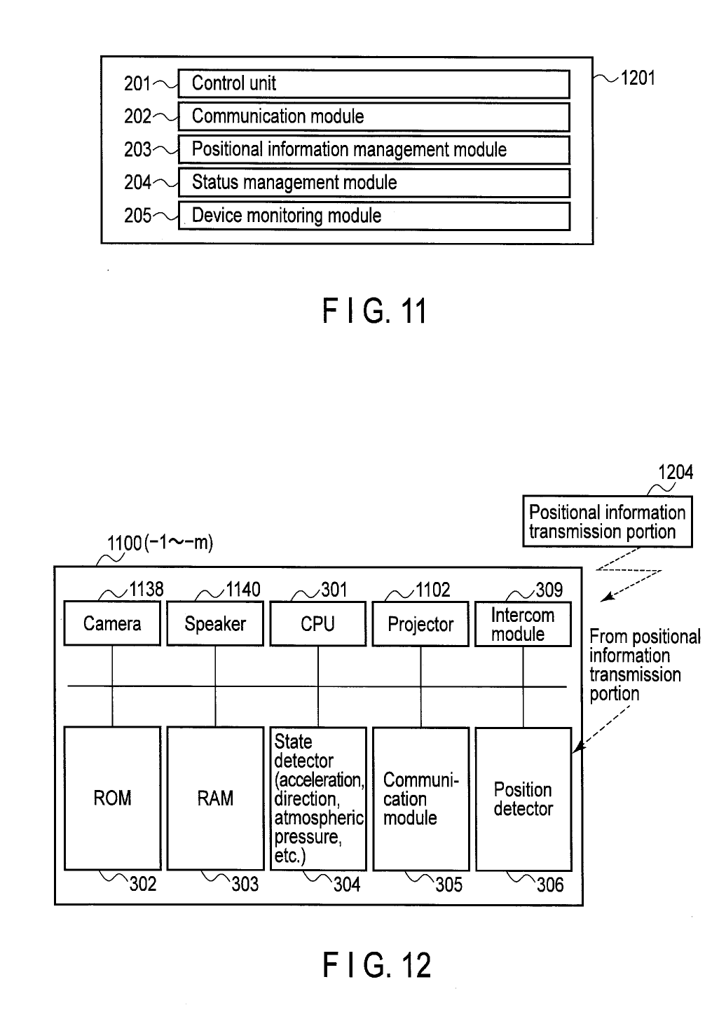

FIG. 11 is a schematic diagram showing the main elements of the information management sever shown in FIG. 10 by blocks.

The information management server 1201 shown in FIG. 11 includes a control unit 201, a communication module 202, a positional information management module 203, a status management module 204, and a device monitoring module 205.

The control unit 201 controls the overall information management server.

The communication module 202 is connected to network NTW, and controls transfer of information by the communication with various devices on the network, for example, manufacturing apparatuses A01 to Axy, B01 to Bxy, C01 to Cxy, . . . , XYxy.

The positional information management module 203 manages the worker ID and the position of the worker and/or the manager (supervisor) ID and the position of the manager (supervisor) received from each of wearable devices 1100-1 to 1100-m and the system controller 1202. A supervisor and a manager may be assigned separately, or one may hold the additional post. For example, when a work area expands to a plurality of buildings or floors, it is possible to assume that each building or floor has a supervisor, and at least one manager who manages the whole work area exists.

The status management module 204 manages the status of the worker specified by the worker ID received from each of wearable devices 1100-1 to 1100-m. The statuses of the workers are, for example, [A] working, [B] moving, and [C] waiting. Of the workers' statuses, when the workers are working ([A]), more specific statuses such as [A1] positional information on wearable devices 1100-1 to 1100-m transmitted from these wearable devices remains at predetermined positions, [A2] principally repetitive operations are repeated at a substantially constant period, and [A3] a picking (parts-retrieval) operation for work completion or preparation of the next work is performed at a substantially constant period are to be determined. Of the workers' statuses, when the workers are moving ([B]), more specific statuses such as [B1] positional information on wearable devices 1100-1 to 1100-m transmitted from these wearable devices is moving in a certain direction every time the transmission is made, and [B2] the direction of movement is the direction of approaching the workers' work area or moving away from the workers' work area are to be determined. Of the workers' statuses, when the workers are waiting ([C]), more specific statuses such as [C1] positional information on wearable devices 1100-1 to 1100-m transmitted from these wearable devices remains at predetermined positions which are the standby positions (i.e., in a non-work area) are to be determined.

The device monitoring module 205 monitors the operating statuses of manufacturing apparatuses A01 to Axy, B01 to Bxy, C01 to Cxy, . . . , and XYxy. That is, manufacturing apparatuses A01 to Axy, B01 to Bxy, C01 to Cxy, . . . , and XYxy notify the information management server 1201 of the statuses of the apparatuses at regular time intervals or when the statuses have changed. The information management server 1201 ascertains the statuses of all manufacturing apparatuses in receipt of the notification of the status information from the individual manufacturing apparatuses by the device monitoring module 205, and when abnormality is detected, the positional information and status of the corresponding manufacturing apparatus are notified to the manager terminal (system controller) 1202. Simultaneously with the above, the workers' statuses are judged, and a candidate for the worker who can most efficiently deal with the manufacturing apparatus having the abnormality is picked out and presented to the manager terminal 1202.

That is, the information management server 1201 having the above structure notifies the positional information and status of the corresponding manufacturing apparatus to the manager terminal 1202 when abnormality is detected by the device monitoring module 205. Simultaneously with the above, the workers' statuses are judged, and a candidate for the worker who can most efficiently deal with the manufacturing apparatus having the abnormality is determined and presented to the manager terminal 1202.

FIG. 12 is a schematic diagram showing the main elements of the wearable device shown in FIGS. 1 and 10 by blocks.

The wearable device 1100 shown in FIG. 12 comprises a control unit 301 including a processor (CPU), and a ROM 302, a RAM 303, a state detector 304, a communication module 305, a position detector 306, an intercom module (including a microphone and a speaker) 309 which are connected to each other by a control bus. Also, the projector 1102, a camera 1138, and the speaker 1140 are connected to the control bus.

The control unit 301 controls the overall wearable device (terminal for the worker) in accordance with a program held in the ROM 302 using the RAM 303 as a work memory.

The state detector 304 includes various sensors such as an acceleration sensor, a gyroscope sensor, and a barometer, and detects the worker's status based on items of information output from the respective sensors. Here, the worker's status is, for example, [A] working, [B] moving, or [C] waiting, as described above. Also, the specifics and the steps of the work are determined. Moreover, when it is determined that the worker's operation is one which agrees with a feature amount acquired from the worker, etc., in advance, based on the advanced information obtained by the acceleration sensor, the gyroscope sensor, and the barometer, matters such as which of a plurality of steps is being carried out and whether that step has finished are determined. Also, by using the microphone, whether the assumed work is in process is determined based on the environmental sound specific to the working process in question acquired in advance and its feature amount.

The worker's status described above can be detected by the information management server 1201 or the system controller 1202 by the communication between the wearable device 1100 and the information management server 1201 or the system controller 1202 through network NTW. The positional information transmission portion 1204 detects emission of light (the stray light 1118) from the projector 1102 of the wearable device 1100, and reports the worker's status to the information management server 1201 or the system controller 1202.

The communication module 305 reports the position of the wearable device to the information management server 1201 or the system controller 1202 through network NTW.

The position detector 306 receives the positional information from the positional information transmission portion 1204, and detects the position of the wearable device. The camera 1138 images the situation which can be seen from the wearable device and transmits it to the information management server 1201 or the system controller 1202 on the basis of a transmission request from the manager (supervisor) or a transmission instruction given by the worker who is the wearer (of the wearable device). The speaker 1140 notifies the worker who is the wearer (of the wearable device) of a message transmitted from the manager (supervisor) or information held in the information management server 1201, for example, as speech information (that is, reproduces the speech information).

The intercom module 309 carries out speech transmission with the outside. In this way, the worker and the manager can communicate vocally.

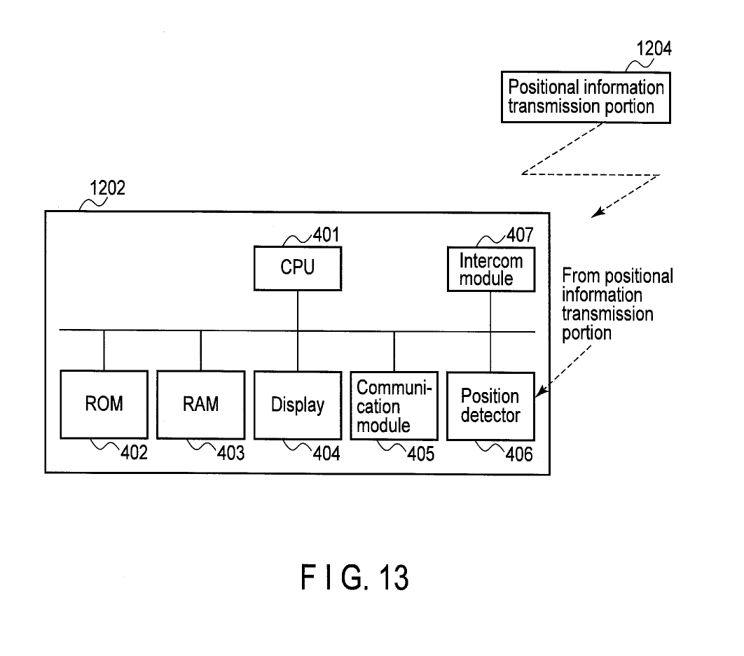

FIG. 13 is a schematic diagram describing an example of the main elements and structure of the system controller shown in FIG. 1 or FIG. 10.

As shown in FIG. 13, the system controller 1202 comprises a ROM 402, a RAM 403, a display 404, a communication module 405, a position detector 406, and an intercom module 407 which are connected to a control unit 401 including a processor (CPU) via a control bus or a data bus.

The system controller 1202 may be, for example, a fixed terminal which is used in a fixed state such as a personal computer (PC), as shown in FIG. 1, or a tablet PC which can be arbitrarily moved. Preferably, the system controller 1202 should include the hands-free-enabled display (wearable device) 404 and a tablet PC or smartphone (control unit), and the manager (or supervisor) should be able to move while the (hands-free-enabled) display is being worn. The display (which is hands-free-enabled) should more preferably display information received by the personal computer (tablet PC) (at a predetermined position) in the extension of the wearer's line of sight.

The control unit 401 controls the system controller 1202 in accordance with a program held in the ROM 402 using the RAM 403 as a work memory. The display 404 displays various kinds of information such as the position or status of the worker (or the fact that the worker is absent or is away from the intended area because of a sudden illness, etc.) (which is acquired via the wearable device), the position or information on the manufacturing apparatus having the abnormality, a candidate for the worker who can most efficiently deal with the manufacturing apparatus having the abnormality. When the system controller 1202 is, for example, a tablet PC (or a smartphone) which can be moved to an arbitrary position, the position detector 406 receives positional information transmitted by the positional information transmission portions 1204 (-1 to -n), and detects (specifies) the current position of the system controller 1202. As described above, the system controller 1202 may be configured such that wearable device 1100-x for the manager (“-x” is added for discrimination) is used as the display, and the system controller 1202 receives information transmitted by a control unit associated with wearable device 1100-x, and displays (reports) the received information to the manager. In this case, wearable device 1100-x for the manager receives the positional information transmitted by the positional information transmission portions 1204 (-1 to -n) and detects (specifies) the current position of wearable device 1100-x for the manager. The manager's (supervisor's) positional information and the manager (supervisor) ID which have been detected are transmitted to the information management server 1201 by the communication module 405 via network NTW. Also, by the intercom module 407, the manager (supervisor) can talk to remotely stationed personnel such as workers.

The information management server 1201 manages the position of an arbitrary worker and the status of the worker (the position of the manager [supervisor] as required) acquired via network NTW. By making an inquiry to the information management server 1201 from the system controller 1202, the manager (supervisor) can ascertain the position of the arbitrary worker and the status of that worker.

Further, assuming the case where the work area 1001 expands to a plurality of buildings or floors, if a supervisor is assigned for each of the buildings or floors and at least one manager who manages the entire work area 1001 exists, it is preferable that a controller for the manager (not shown), which further compiles the information that the information management server 1201 acquires from the system controller 1202, which is provided in terms of the work area 1001, for example, should be provided. That is, by providing the controller for the manager, even if the work area 1001 expands to a plurality of buildings or floors, the manager can ascertain (manage) the position and status of an arbitrary worker in an arbitrary floor or building.

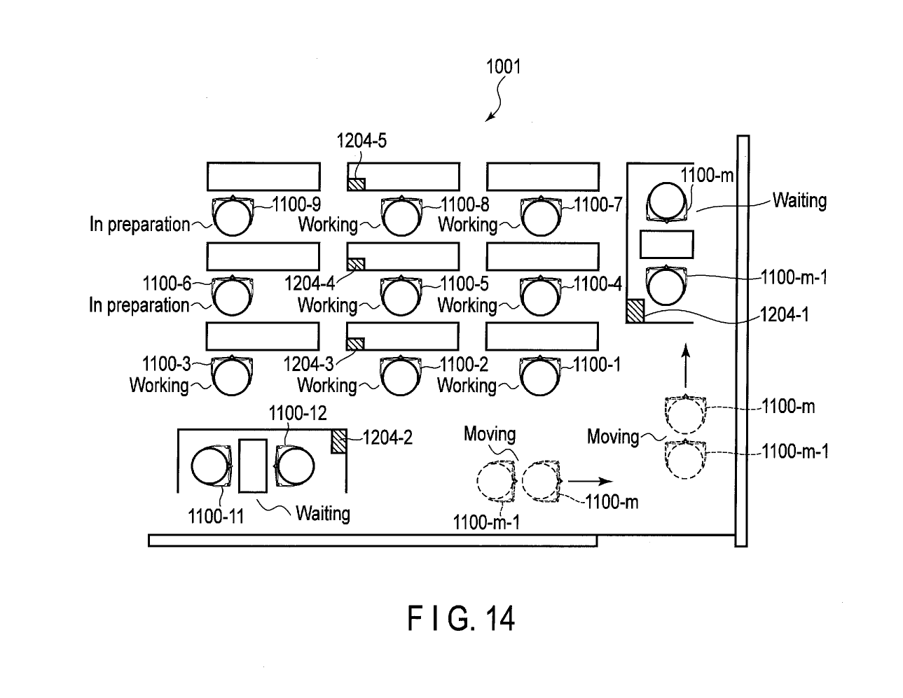

Further, when the control unit (CPU) 201 of the system controller 1202 is to display the information regarding the workers on the display 404, as FIG. 14 illustrates an example of the form of the display, output image information may be produced in such a way that the information is displayed as a bird's-eye view which is the view seen from the above, for example. Similarly, when the information regarding the workers is displayed on the display 404, the output image information may be produced in such a way that colors for display are changed according to the workers' statuses, i.e., red for working, yellow for moving, and green for waiting. Also, when the information regarding the workers is displayed on the display 404, the system controller 1202 may display an arbitrary number of buttons for switching the display mode (display form) whereby an instruction such as “display only the workers who are waiting”, for example, can be input, and produce output image information in which the specifics to be displayed are changed based on the instruction input by the button, thereby displaying the changed output image information (on the display 404).

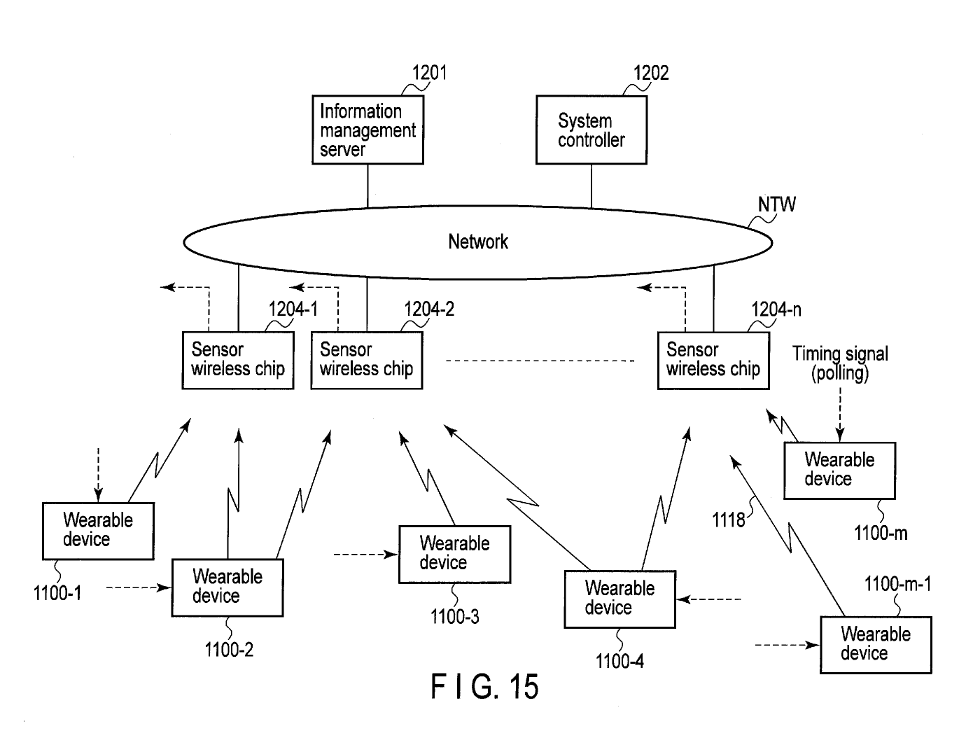

FIG. 15 is a schematic diagram showing the main elements of the electronic device and the system which recognizes the electronic device as blocks, and showing an example of notifying the identification information (device ID) from wearable devices 1100-1 to 1100-m to the system controller 1202 or the information management server 1201 shown in FIG. 10.

In the system shown in FIG. 15, the information management server 1201 and the system controller 1202 are connected to network NTW. An arbitrary number of sensor wireless chips (positional information transmission portions) 1204-1 to 1204-n (where n is a positive integer) are connected to network NTW.

In accordance with the output instructions from the system controller 1202, wearable devices 1100-1 to 1100-m receive timing signals (polling) that the sensor wireless chips (positional information transmission portions) 1204-1 to 1204-n output at predetermined timings, respectively. The timing signals (polling) include information on the timing at which the respective wearable devices 1100-1 to 1100-m output their own identification information (device ID). As exemplified in FIG. 6, each of wearable devices 1100-1 to 1100-m superposes their own identification information (device ID) on the light 1108 output by the projector 1102 in the intermittent ID modulation periods defined by the received timing signals, that is, a time frame including the ON time of a predetermined length and the OFF time of a predetermined length which are repeated at regular time intervals. Accordingly, the light output by the projector 1102 is that modulated by a specific signal capable of displaying the device ID unique to the corresponding one of the wearable devices 1100-1 to 1100-m. Arbitrary sensor wireless chips 1204-1 to 1204-n detect beams of stray light 1118 of the light 1108 output from their respective wearable devices 1100-1 to 1100-m. Each of the sensor wireless chips 1204-1 to 1204-n reports the worker ID (information specifying the wearer) and the device ID of the detected wearable devices 1100-1 to 1100-m to the information management server 1201 (or the system controller 1202) through network NTW at regular time intervals.

The work management system of the embodiment according to the above structure is characterized in the following point, in particular.

Normally, in a production site having many manufacturing apparatuses, a worker for managing/performing the maintenance of the manufacturing apparatuses carries out the inspection/maintenance/servicing operation according to the manufacturing apparatus. At this time, the time or like required for the working process which is necessary for grasping the productivity of each work is recorded according to the process. However, in this recording, since the determination of the work status is not automated such as the worker needing to stop the work and make a record on a recording medium, it takes a lot of trouble. Also, while a scheduled inspection/maintenance operation is carried out in a normal state, when a problem or a trouble occurs in a certain manufacturing apparatus unexpectedly, the production manager must select a person who can deal with the matter among the whole workers present at that time and make him/her deal with the manufacturing apparatus having the trouble. When there is only a one-to-one communication means between the manager and many workers (i.e., a call by a mobile device, etc.), the situation must be ascertained separately. Therefore, it takes time to ascertain the place (position) of the worker at that time. and the status of the worker.

In the present embodiment, in order to ascertain and improve the efficiency of the worker's operation, action estimated information on the working process and work status, etc., including the traveling time from the current position to the target manufacturing apparatus is managed and recorded in the system using the position detection function and the function of making a judgment based on agreement with the feature amount of the worker's operation and environment acquired in advance. In this way, it becomes possible to automate the determination of the work status, and derive improvements which contribute to elimination of useless actions and reduction of time in the working process including the traveling time by using a result of the determination. Also, as the manager of the manufacturing apparatuses confirms the result in real time, giving work instructions efficiently to the maintenance/servicing worker is enabled. Here, time taken for all of the operation processes including a movement of the working place by the position determination is recorded and used for improving the efficiency. Also, a worker to whom the operation can be requested can be selected easily by confirming the current detailed work status of the worker obtained from the action estimation (whereby an instruction can be given to a worker who will not be interrupted by talking to the manager, which may reduce the overall working efficiency).

In view of the above gist, the work management system of the present embodiment can collect the above-identified information by the information management server 1201, thereby managing data such as the worker who is present and the place where the worker is positioned, and the exact status of the worker. Also, even if the manager (supervisor) is movable, the work management system of the present embodiment can identify the position of the manager (supervisor) at a predetermined timing. Moreover, the work management system of the present embodiment can notify the location of the manufacturing apparatus having an abnormality or information on such a manufacturing apparatus, and a candidate for the worker who can most efficiently deal with the manufacturing apparatus having the abnormality to the manager.

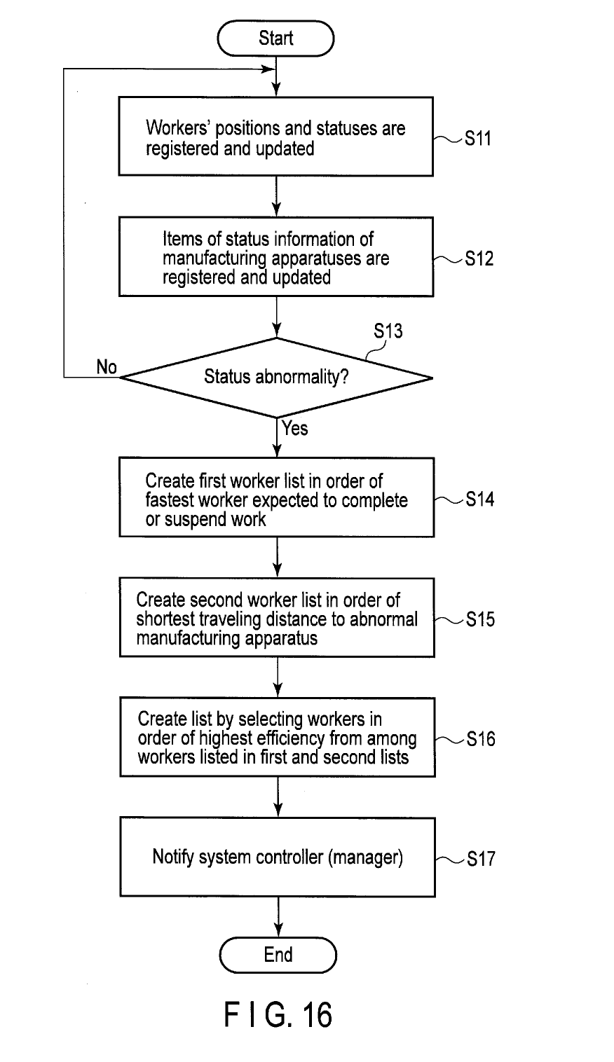

Steps to be taken to deal with the occurrence of an abnormality of the manufacturing apparatus will be described with reference to a flowchart shown in FIG. 16.

First, when worker information representing the whole workers' positions and statuses is input through the system controller 1202, the information management server 1201 sorts each item of worker information and registers and updates the same (step S11). Next, when status information is received from all of the manufacturing apparatuses, that status information is registered and updated (step S12). Here, it is determined whether the status is normal or not for each item of status information from the manufacturing apparatuses (step S13), and when no abnormality is found, the flow returns to processes of steps S11 and S12. When an abnormality is detected from the status information transmitted from the respective manufacturing apparatuses, a first worker list having workers listed in the order of the fastest who is expected to complete or suspend the work is created (step S14), a second worker list having workers listed in the order of the shortest traveling distance to the manufacturing apparatus in which the abnormality is detected is created (step S15), and a list in which the workers are selected in the order of the highest efficiency from among the workers in the first and the second lists is created (step S16), and that list is notified to the system controller 1202 as a maintenance worker candidate list (step S17). In this way, the manager can refer to the maintenance worker candidate list of the system controller 1202, designate the worker as appropriate, and instruct the designated worker to perform maintenance of the manufacturing apparatus having the abnormality.

Note that the function which enables the display of the current positions and statuses of the workers and talking with the workers can be realized by not only an ordinary screen monitor or a mobile computer (a tablet, a smartphone), but also a spectacle-type wearable device.

Further, when an acceleration sensor, a gyroscope sensor, and a (high-level) barometer provided in the spectacle-type wearable device are used, it becomes possible to ascertain the working process and the work status of the worker based on the status information at the time of working by the action estimation.

Furthermore, by using an acoustic sensor such as a microphone provided in the spectacle-type wearable device, it becomes possible to ascertain the working process and the work status of the worker based on environmental sound specific to that work by the action estimation.

Furthermore, it becomes possible to ascertain the worker's status by the action estimation by combining the status information at the time of work and the environmental sound specific to the work as described above.

Furthermore, as the worker utilizes the spectacle-type wearable device, the manager's work instructions can be notified by displaying them in the form of characters and graphics.

Furthermore, by utilizing the spectacle-type wearable device, recorded information can be displayed as the worker's process progress information.

Here, as the information input means for providing the work instructions to the workers, a tablet or a smarphone can be used as a terminal device.

As the system, the worker's position and information can be visually displayed as a list or on a map of the workplace.

As describe above, since the work management system of the present embodiment monitors whether there is an abnormality in the manufacturing apparatuses as well as ascertaining the positions and the statuses of all workers including the manager by the information management server 1201, when an abnormality occurs in any of the manufacturing apparatuses, it is possible to automatically select an efficient worker and notify that worker as a candidate. In this way, since the manager can quickly ascertain the overall situation when an abnormality has occurred, select a worker appropriately, and make the selected worker deal with the apparatus having the abnormality, efficiency can be achieved dramatically in terms of safety management.

Also, the above-mentioned work management system can manage and record the positions of the workers, and the working processes and statuses in detail. From the recorded history of the workers, it is possible to ascertain the time of each working process including the time required for moving. By using these history records, an improvement can be added to a method of selecting a worker by the working manager. Also, since the statuses of the workers can be ascertained in detail, the information management module in the information management server can automatically select the most suitable worker in newly making an operation request, and store and execute a program to be provided to the manger with priority as a candidate. Since the manager can use not only his/her own judgment, but also the work management system's recommended proposal, it is possible to reduce the risk of giving erroneous work instructions.

Further, as the workers' statuses to be ascertained, the work management system can obtain the statuses such as the work will be suspended if the worker talks with others, or a talk with others places the worker at risk of performing the operation unsafely because he/she is working high up, etc. Consequently, the system and the manager can ascertain in real time the possibility of reducing the overall efficiency of the work if suspended or bringing the worker to an unsafe status which would increase the risk of causing accidents with respect to workers whose work should not be suspended carelessly.

Note that detecting the statuses of the workers' devices is performed by the operation/status determination by extraction of the feature amounts from various kinds of sensor information. For the determination, machine learning may be used. The other kinds of determination technique may be used. In the devices for the workers, the statuses detected by the state detector may be displayed by a progress bar or by a working process list. Also, the device for the manager can acquire not only the information on the workers, but also the information on the manufacturing apparatuses from the information management server for display.

As described above, it is possible to improve the rate of operation of the manufacturing apparatus by taking measures for improvement by ascertaining the status of each worker including the worker's position and managing and recording the statuses and positions, and reducing the time required for maintenance/servicing by selecting the most appropriate worker in the work instructions in real time.

Further, in the above embodiment, although a case where abnormality of manufacturing apparatuses is monitored has been described, the embodiment can also be applied to a case where abnormality of products is automatically detected when the products on a production line are to be inspected.

As described above, with the work management system according to the present embodiment, the spectacle-type electronic device can report the positional information and the operating statuses in the workplace to a control device, thereby presenting assistance information regarding work to the workers. In other words, by utilizing the features of the spectacle-type electronic device and managing information associated with various work statuses in the workplace, adequate assistance information for achieving the efficiency of work can be presented to the workers.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A work management system comprising:
an information management server configured to receive items of status information transmitted from a plurality of targets of work, respectively, through a network, and to determine an occurrence of abnormality of each of the targets of work based on the items of status information;
a control device associated with a manager and configured to manage workers working on the plurality of targets of work, each worker using a spectacle-type electronic device, wherein
the spectacle-type electronic device is configured to:
transmit worker information indicating a position and a work status of each worker to a communication device on the network,
receive information from the communication device on the network, and
present the received information to the workers on a display of the spectacle-type electronic device.

2. The work management system of claim 1, wherein the spectacle-type electronic device is further configured to display a current position and a status of the worker, and enable talking with other workers.

3. The work management system of claim 1, wherein when the spectacle-type electronic device further comprises at least one of an acceleration sensor, a gyroscope sensor, and a barometer, a working process and the work status of the worker are ascertained by action estimation from status information at the time of work of the acceleration sensor, the gyroscope sensor, and the barometer.

4. The work management system of claim 1, wherein when the spectacle-type electronic device further comprises an acoustic sensor, a working process and the work status of the worker are ascertained by action estimation from an environmental sound specific to the work using the acoustic sensor.

5. The work management system of claim 4, wherein the worker's status is ascertained by action estimation by combining the work status of the worker at the time of work and the environmental sound specific to the work.

6. The work management system of claim 1, wherein a work instruction from the control device is notified by displaying the work instruction in the form of characters and graphics.

7. The work management system of claim 1, wherein information recorded in the information management server is displayed as the worker's process progress information.

8. A work management system comprising:
an information management server configured to receive items of status information transmitted from a plurality of targets of work, respectively, through a network, and to determine an occurrence of abnormality of each of the targets of work based on the items of status information;
a spectacle-type electronic device configured to:
transmit worker information indicating a position and a work status of a worker using the spectacle-type electronic device to a communication device on the network,
receive information from the communication device on the network, and
present the received information to the worker; and
a control device configured to collect the worker information transmitted from the spectacle-type electronic device through the network to provide the worker information to the information management server, and to transmit the information to be presented to the worker to the spectacle-type electronic device, wherein
the information management server is configured to ascertain the position and the work status of each of a set of workers from the worker information provided from the control device, and when an abnormality with respect to one of the plurality of targets of work is detected, the information management server selects the worker from a plurality of workers who is able to most quickly deal with the target of work in which the abnormality is detected and presents that worker to the control device.

9. The work management system of claim 8, wherein the information management server is configured to:
register and update the position and the work status of each of the workers from the plurality of workers based on the worker information;
register and update the items of status information from the respective targets of work;
detect the abnormality based on the items of status information from the respective targets of work;
compare, when the abnormality is detected, the registered and updated positions of the workers with reference to a position of a target of work detected to have the abnormality; and
sort the workers in the order closest to the target of work in which the abnormality is detected and present the sorted workers to the control device.

10. The work management system of claim 8, wherein the information management server is configured to:
register and update the position and the work status of each of the workers based on the worker information;
register and update the items of status information from the respective targets of work;
detect the abnormality based on the items of status information from the respective targets of work;
compare the registered and updated work statuses of the workers when the abnormality is detected; and
sort the workers in order based on how quickly each worker is expected to complete or suspend the work based on the work statuses and present the sorted workers to the control device.

11. The work management system of claim 8, wherein the information management server is configured to:
register and update the position and the work status of each of the workers based on the worker information;
register and update the items of status information from the respective targets of work;
detect the abnormality based on the items of status information from the respective targets of work;
compare, when the abnormality is detected, the registered and updated positions of the workers with reference to a position of a target of work detected to have the abnormality, and compare the registered and updated work statuses of the workers; and
sort the workers in order based on how close each worker is to the target of work in which the abnormality is detected, and how quickly each worker is expected to complete or suspend the work based on the work statuses, and present the sorted workers to the control device.

12. An information management server which is used for a work management system, the work management system comprising:
a set of spectacle-type electronic devices, each spectacle-type electronic device associated with a worker from a set of workers who work on a plurality of targets of work, and each spectacle-type electronic device configured to:
transmit worker information indicating a position and a work status of each worker to a communication device on a network,
receive information from the communication device on the network, and
present the received information to the worker; and
a control device configured to collect the worker information transmitted from each of the spectacle-type electronic devices through the network, and to transmit the information to be presented to each worker to the spectacle-type electronic device associated with the worker, wherein
the information management server is configured to:
receive items of status information transmitted from a plurality of targets of work, respectively, through the network, and to determine an occurrence of an abnormality of each of the targets of work based on the items of status information; and
ascertain the position and the work status of each of the set of workers by acquiring the worker information from the control device, and select, when the abnormality of any of the plurality of targets work is detected, a target worker who is able to most quickly deal with the target of work in which the abnormality is detected and present the target worker to the control device.

13. The information management server of claim 12, wherein the information management server is configured to:
register and update the position and the work status of each of the set of workers based on the worker information;
register and update the items of status information from the respective targets of work;
detect abnormality based on the items of status information from the respective targets of work;
compare, when the abnormality is detected, the registered and updated positions of the set of workers with reference to a position of a target of work detected to have the abnormality; and
sort the set of workers based on the location of each of the set of workers with respect to the target of work in which the abnormality is detected and present the sorted workers to the control device.

14. The information management server of claim 12, wherein the information management server is configured to:
register and update the position and the work status of each of the workers based on the worker information;
register and update the items of status information from the respective targets of work;
detect abnormality based on the items of status information from the respective targets of work;
compare the registered and updated work statuses of the set of workers when the abnormality is detected; and
sort the set of workers based on how quickly each worker is expected to complete or suspend the work based on the work statuses and present the sorted workers to the control device.

15. The information management server of claim 12, wherein the information management server is configured to:
register and update the position and the work status of each of the set of workers based on the worker information;
register and update the items of status information from the respective targets of work;
detect abnormality based on the items of status information from the respective targets of work;
compare, when the abnormality is detected, the registered and updated positions of the set of workers with reference to a position of a target of work detected to have the abnormality, and also compare the registered and updated work statuses of the workers; and
sort the set of workers based on the location of each of the set of workers with respect to the target of work in which the abnormality is detected, and based on how quickly each worker is expected to complete or suspend the work based on the work statuses, and present the sorted workers to the control device.
